(19) United States
(12) Patent Application Publication
(10) Pub. No.: US 2001/0009602 A1
(43) Pub. Date: Jul. 26, 2001

(54) Method and apparatus for outputting image data

(76) Inventor: Takashi Nakayama, Saitama (JP)

Correspondence Address: McGinn & Gibb, PLLC, Suite 200, 8321 Old Courthouse Road, Vienna, VA, 22182-3817, US

(21) Appl. No.: 09/766,651

(22) Filed: Jan. 23, 2001

(30) Foreign Application Priority Data
Jan. 25, 2000 (JP) 2000-17978

(51) Int. Cl. H04N 5/76; H04N 5/225; H04N 5/91

(52) U.S. Cl. 386/46; 386/117

(57) ABSTRACT

An image data output apparatus for outputting to a second medium, which is a different type of medium than a first medium, image data recorded in the first medium received from a customer, the apparatus, which includes: a reader for reading out the image data recorded in the first medium; an output unit for outputting the image data to the second medium; a digital contents storage unit for storing digital contents to be stored in the first medium; a selector for selecting from a plurality of said digital contents stored in said digital contents storage unit said digital contents to be provided to the customer based on a predetermined selection condition; and a recorder for recording said selected digital contents in the first medium.

This patent application claims priority from a Japanese patent application No.2000-017978 filed on Jan. 25, 2000, the contents of which are incorporated herein by reference.

### BACKGROUND OF THE INVENTION

1. Field of the Invention

The present invention relates to a method and apparatus for outputting image data. In particular, the present invention relates to an apparatus for outputting image data recorded in a memory card to another medium.

2. Description of the Related Art

In general, media conversions, such as printing image data on paper by reading out image data photographed by a digital camera from a memory card and re-recording data on another medium such as a CD-R, are conducted. Also, a media conversion service, which is undertaken by shops like photo shops conducting these kinds of media conversion, is widely known. For example, the Japanese Patent Application Laid-Open No.H11-109518 discloses an apparatus for receiving accessory data from a digital camera such as the number of prints of photographed images and correctly performing a media conversion service. There are two methods for a media conversion service of this type. One is a method for a customer to conduct a media conversion by himself or herself. The other is a method for a person other than a customer, such as a sales clerk, to conduct a media conversion of a memory card received by a customer.

In both methods, image data is read out from a memory card in which photographed image data has been recorded, but then the memory card is returned to the customer in the same state. Incidentally, even if photographed image data is recorded, the memory card usually has available memory. Moreover, when the read-out image data is no longer needed, the available memory of the memory card may be increased if the unnecessary data is deleted.

At photo shops, it is popular that publicity handouts made of a paper medium, which contains sales information or advertisements, are supplied with developed pictures when the developed pictures are returned to customers. However, when using a media conversion service according to the conventional art, it is difficult to unify the supplied publicity handouts made of a paper medium because the formats of media returned to customers are different. In particular, it is more difficult for a customer to receive publicity handouts when the customer himself or herself conducts a media conversion by operating a terminal.

Moreover, if sales information or advertisements were digital data instead of a paper medium, advertisements may be able to be in forms of animations or music, thereby customers may receive publicity handouts in various forms.

### SUMMARY OF THE INVENTION

Therefore, it is an object of the present invention to provide a method and apparatus for outputting image data by taking advantage of the available memory of a memory card after a media conversion is conducted, which is capable of overcoming the above drawbacks accompanying the conventional art. The above and other objects can be achieved by combinations described in the independent claims. The dependent claims define further advantageous and exemplary combinations of the present invention.

According to the first aspect of the present invention, an image data output apparatus for outputting to a second medium, which is a different type of medium than a first medium, image data recorded in the first medium received from a customer, which includes: a reader for reading out the image data recorded in the first medium; an output unit for outputting the image data to the second medium; a digital contents storage unit for storing digital contents to be stored in the first medium; a selector for selecting from a plurality of the digital contents stored in the digital contents storage unit the digital contents to be provided to the customer based on a predetermined selection condition; and a recorder for recording the selected digital contents in the first medium.

The first medium may include a memory card in which the image data is recorded by an image capturing apparatus that records and plays the image data.

The digital contents may include advertisement information to be provided to the customer in exchange for a discount of the service rate for outputting the image data from the first medium to the second medium.

The digital contents storage unit may store digital contents to be provided in the second medium along with the image data. The recorder may record the selected digital contents in the second medium. The digital contents may be selected by the customer. The digital contents may be selected as not being displayed when being printed. The digital contents may include pay digital data to be received by the customer.

The image data output apparatus may further include a customer information input unit for inputting information relating to the customer for reference, and the selector may select the digital contents by referring to the customer information.

The image data output apparatus may further include a customer condition storage unit for storing a condition relating to the customer as the predetermined selection condition, and wherein the selector may select the digital contents by collating the customer information with the customer condition.

The image data may include accessory data showing the environment of which the image data is recorded in the first medium, and the image data output apparatus may further include: an accessory data reader for reading the accessory data from the image data; and a recording condition storage unit for storing a recording condition associating the recorded environment with a recording format of the digital contents, and wherein the selector may include a recording condition collator for selecting the digital contents by collating the accessory data with the recording condition.

The accessory data may relate to the type of image capturing apparatus that photographed the image data, and the recording condition defines a recording format to be played by the image capturing apparatus.

The image data output may further include an available memory detector for detecting available memory of the first medium, and wherein the selector may select the digital contents based on the detected available memory.

The image data output apparatus may further include a data size storage unit for storing a data size of the digital contents, and wherein the selector may select the digital contents having a smaller data size than the available memory by collating the detected available memory of the first medium with the data size.

The image data output apparatus may further include: an after-treatment condition input unit for inputting an after-treatment condition showing whether or not to erase at least a part of the image data from the first medium after completing the reading of the image data from the first medium; and an eraser for erasing at least a part of the image data from the first medium based on the after-treatment condition.

The image data output apparatus may further include: a display for displaying to the customer some of the digital contents as choices; and an operation control for selecting desired digital contents for recording in the first medium from the digital contents displayed by the display.

The operation control may select desired digital contents for providing to the second medium from the digital contents displayed by the display.

The image data output apparatus may further include a calculator for calculating a price of the digital contents recorded in the first medium based on the predetermined selection condition.

The calculator may calculate the price of the digital contents recorded in the second medium based on the predetermined selection condition.

The image capturing apparatus having a camera display for displaying some of the digital contents as choices and a camera operation control for selecting desired digital contents from the digital contents may display the digital contents as the choices and record the digital contents by selecting with the camera operation control.

According to the second aspect of the present invention, an image data output system for outputting image data, which includes: a first medium for recording the image data to be received by a shop for converting a medium and for recording digital contents to be received by a customer; a second medium for recording the image data and for recording digital contents along with the image data to be received by the customer; a reader for reading out the image data recorded in the first medium; an output unit for outputting the image data to the second medium; a digital contents storage unit for storing the digital contents that the shop provides to the customer; a selector for selecting from the digital contents storage unit the digital contents to be provided to the customer based on a predetermined selection condition; a recorder for recording the selected digital contents in at least one of the first and second medium; and an image capturing apparatus for outputting customer information, which includes: an information input unit for inputting by a user's operation information for the image data output apparatus to refer to when selecting the digital contents; and a recorder for recording the information along with the image data in at least one of the first and second medium.

The image capturing apparatus may include: a camera display for displaying the digital contents as choices; and a camera operation control for selecting desired digital contents from the displayed digital contents.

According to the third aspect of the present invention, a method for outputting image data, which includes: reading out from a first medium that stores the image data, which is recorded by an image capturing apparatus; outputting the image data to a second medium, which is a different type of medium than the first medium; selecting from a plurality of digital contents to be stored in at least the first medium that a shop provides to a customer; and recording in the first medium the digital contents.

The recording may record the digital contents also in the second medium. The recording may record the digital contents selected by the selecting based on a predetermined selection condition.

The selecting may include inputting information relating to the customer for a reference, and the selecting may select the digital contents by referring to the customer information. The digital contents may be selected by the customer.

The method for outputting image data may further include displaying displays at least one of the digital contents before displaying the image data stored in the first medium.

The displaying may display at least one of the digital contents before displaying the image data stored in at least one of the first and the second medium. The displaying may be selected whether to display the digital contents when printing.

The method for outputting image data may further include storing a condition relating to the customer as the predetermined selection condition, and wherein the selecting may select the digital contents by collating the customer information with the customer condition.

The image data may include accessory data showing the environment of which the image data is recorded in the first medium, the image data output apparatus may further include: reading the accessory data from the image data; and storing a recording condition associating the recorded environment with a recording format of the digital contents, and wherein the selecting may include selecting the digital contents by collating the accessory data with the recording condition.

The method for outputting image data may further include detecting available memory of the first medium, and wherein the selecting may select the digital contents based on the detected available memory.

The method for outputting image data may further include storing a data size of the digital contents, and wherein the selecting may select the digital contents having a smaller data size than the available memory by collating the available memory of the first medium with the data size.

The method for outputting image data may further include: inputting an after-treatment condition showing whether or not to erase at least a part of the image data from the first medium after completing the reading of the image data from the first medium; and erasing at least a part of the image data from the first medium based on the after-treatment condition.

The method for outputting image data may further include: displaying to the customer some of the digital contents as choices; and selecting desired digital contents for recording in the first medium from the digital contents displayed by the display.

The selecting may select desired digital contents for recording in the second medium from the digital contents displayed by the display.

The method for outputting image data may further include calculating a price of the digital contents recorded in the first medium based on the predetermined selection condition.

The calculating may calculate the price of the digital contents recorded in the second medium based on the predetermined selection condition.

According to the fourth aspect of the present invention, a recording medium storing a program for outputting image data, which is executable at a computer, wherein the program includes: a reading module for reading out the image data recorded in a first medium; an outputting module for outputting the image data to a second medium; an selecting module for selecting digital contents; and a recording module for recording digital contents that the image capturing apparatus reproduces in one of the first and second medium.

The program may further include a displaying module for displaying at least one of the digital contents before displaying the image data stored in one of the first and second medium.

The program may further include a module for the digital contents to be selected as not being displayed when the image is printed.

The selecting module may include inputting information relating to the customer for reference, and the selecting module may select the digital contents by referring to the customer information.

The program may further include a storing module for storing a condition relating to the customer as the predetermined selection condition, and wherein the selecting module may select the digital contents by collating the customer information with the customer condition.

The image data may include accessory data showing the environment of which the image data is recorded in the first medium, and the program may further include: an accessory data reading module for reading the accessory data from the image data; and a recording condition storing module for storing a recording condition associating the recorded environment with a recording format of the digital contents, and wherein the selecting module may include selecting the digital contents by collating the accessory data with the recording condition.

The program may further include an available memory detecting module for detecting available memory of the first medium, and wherein the selecting module may select the digital contents based on the detected available memory.

The program may further include a data size storing module for storing a data size of the digital contents, and wherein the selecting module may select the digital contents having a smaller data size than the detected available memory by collating the available memory of the first medium with the data size.

The program may further include: an after-treatment condition inputting module for inputting an after-treatment condition showing whether or not to erase at least a part of the image data from the first medium after completing the reading of the image data from the first medium; and an erasing module for erasing at least a part of the image data from the first medium based on the after-treatment condition.

The program may further include: a displaying module for displaying to the customer some of the digital contents as choices; and an operating module for selecting desired digital contents for recording in at least one of the first and second medium from the digital contents displayed by the display.

The program may further include a calculating module for calculating a price of the digital contents recorded in at least one of the first and second medium based on the predetermined selection condition.

The summary of the invention does not necessarily describe all necessary features of the present invention. The present invention may also be a sub-combination of the features described above. The above and other features and advantages of the present invention will become more apparent from the following description of the embodiments taken in conjunction with the accompanying drawings.

### BRIEF DESCRIPTION OF THE DRAWINGS

FIG. 1 is a functional block diagram showing an apparatus for outputting image data according to the first and second embodiments.

FIG. 2 is a functional block diagram showing the details of a digital contents selector and a selection conditions storage unit.

FIG. 3 is a table showing the customer information input by users using a customer information input unit.

FIG. 4 is a table showing the customer conditions for each digital contents stored in a customer condition storage unit.

FIG. 5 is a table showing the recording conditions for each camera type stored in a recording conditions storage unit.

FIG. 6 is a table showing the recordable data size of digital contents stored in a data size storage unit.

FIG. 7 is a table showing the results of retrieved digital contents selected by a collator.

FIG. 8 is a flowchart showing the process of converting media and recording digital contents of an image data output apparatus.

FIG. 9 is a flowchart showing the detailed advertisement recording process at step S20 shown in FIG. 8.

FIG. 10 is a table showing the results of the retrieved digital contents selected by a collator.

FIG. 11 is a flowchart showing the detailed pay digital data recording process at step S20 shown in FIG. 8.

FIG. 12 is a back view of a digital camera having a camera input unit for inputting selection conditions to select digital contents.

FIG. 13 is a flowchart showing the media conversion of an image data output apparatus and the process of recording digital contents.

FIG. 14 is a schematic view showing an interface where customers of an image data output apparatus operate.

FIG. 15 is a back view of a digital camera showing the display playing digital contents recorded by an image data output apparatus.

FIG. 16A is a display showing exemplary digital contents displayed on a camera display of a digital camera shown in FIG. 13.

FIG. 16B is a display showing exemplary digital contents displayed on a camera display of a digital camera shown in FIG. 13.

FIG. 17 is a functional block diagram showing an image data output system according to the present embodiments.

FIG. 18 is a functional block diagram showing an image data output system according to the present embodiments.

### DETAILED DESCRIPTION OF THE INVENTION

The invention will now be described based on the preferred embodiments, which do not intend to limit the scope of the present invention, but exemplify the invention. All of the features and the combinations thereof described in the embodiments are not necessarily essential to the invention.

An image data output apparatus described below is an apparatus placed at a shop such as a photo shop. This apparatus undertakes a media conversion by reading from memory cards image data photographed by customers using a digital camera and the like and outputting the read image data to another medium other than a memory card. Another medium here includes, for example, a paper medium or a CD-R. Also, this apparatus records digital contents provided by the shop to a customer in the available memory of a memory card. The digital contents may also be recorded in another medium. The digital contents here include, for example, digital data such as sales information or advertisements and digital data such as image data or music data for sale. The sales information and advertisements are pieces of information for customers to receive in exchange for a discount of the rate for a media conversion. The image data and music data for sale are information for customers that are received when paying for the data. The user of the image data output apparatus may be a customer himself or herself who takes the media conversion service or a sales clerk of a photo shop.

The first medium described in the claims of the present invention according to the present embodiments is, for example, a memory card. The second medium described in the claims of the present invention according to the present embodiments is, for example, a paper medium or a CD-R.

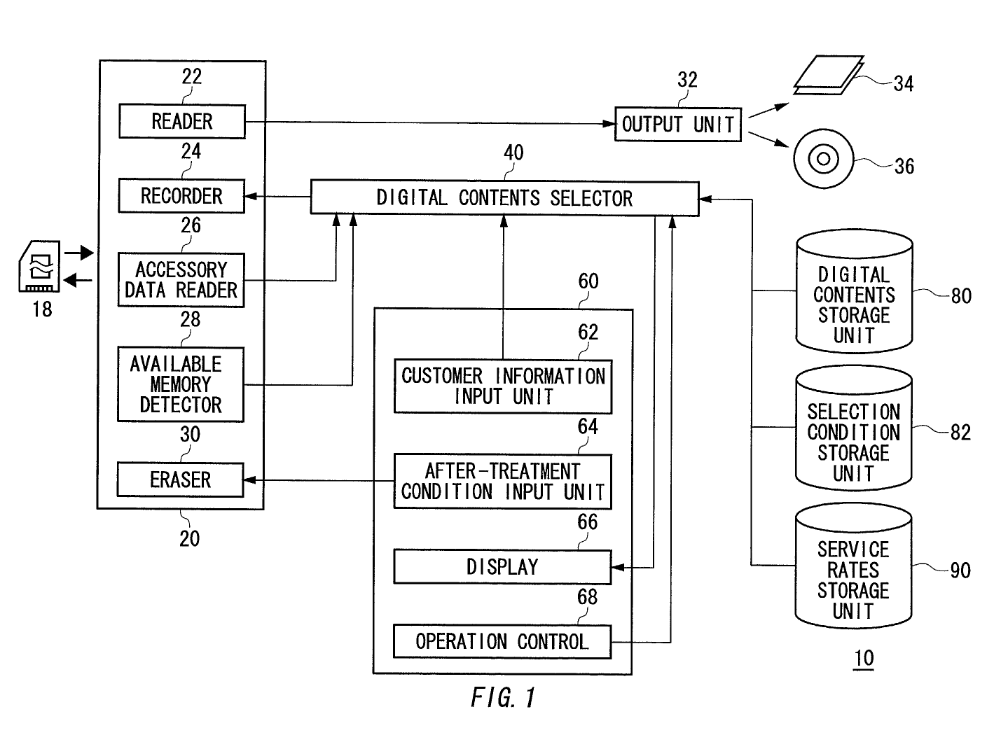

The first embodiment of the present invention will be described in the following. The image data output apparatus according to the present embodiment records sales information or advertisements in a memory card. FIG. 1 is a block diagram showing the image data output apparatus according to the present embodiment. An image data output apparatus 10 includes a memory card drive 20, an output unit 32, a digital contents selector 40, a user interface 60, a digital contents storage unit 80, a selection condition storage unit 82, and a service rates storage unit 90. The memory card drive 20 exchanges digital data with a memory card 18. The output unit 32 outputs image data recorded in the memory card 18 to a different medium other than the memory card 18. The different medium may be, for example, a paper medium 34 or a CD-R 36.

The digital contents selector 40 selects digital contents from the digital contents storage unit 80 based on predetermined selection conditions received by the selection condition storage unit 82. Users operate the image data output apparatus 10 through the user interface 60. The digital contents storage unit 80 stores a plurality of digital contents. The digital contents according to the present embodiment are sales information or advertisements.

The memory card drive 20 includes a reader 22, a recorder 24, an accessory data reader 26, an available memory detector 28, and an eraser 30. The memory card 18 maybe a semiconductor memory such as an EPROM or a compact hard disk. Also, the memory card drive 20 has a slot, though not shown in FIG. 1, and the memory card 18 is inserted to the slot. The reader 22 reads out image data from the memory card 18. The recorder 24 records digital contents selected by the digital contents selector 40 to the memory card 18. The output unit 32 may includes the recorder 24 to record digital contents in another medium. The accessory data reader 26 reads photographic conditions, such as a camera type, as accessory data from the memory card 18. The available memory detector 28 detects the available memory of the memory card 18. The eraser 30 erases at least a part of the image data from the memory card 18.

The user interface 60 includes a customer information input unit 62, an after-treatment condition input unit 64, a display 66, and an operation control 68. The customer information input unit 62 is an interface where users input information relating to customers (referred to as “customer information” hereinafter). The after-treatment condition input unit 64 is an interface for users to input after-treatment conditions. Here, the after-treatment conditions means conditions for deciding whether to erase at least a part of the image data from the memory card 18 after having read the image data from the memory card 18.

The digital contents storage unit 80 may be a standalone database that cannot gain access from the outside or be a network database that can gain access from the outside.

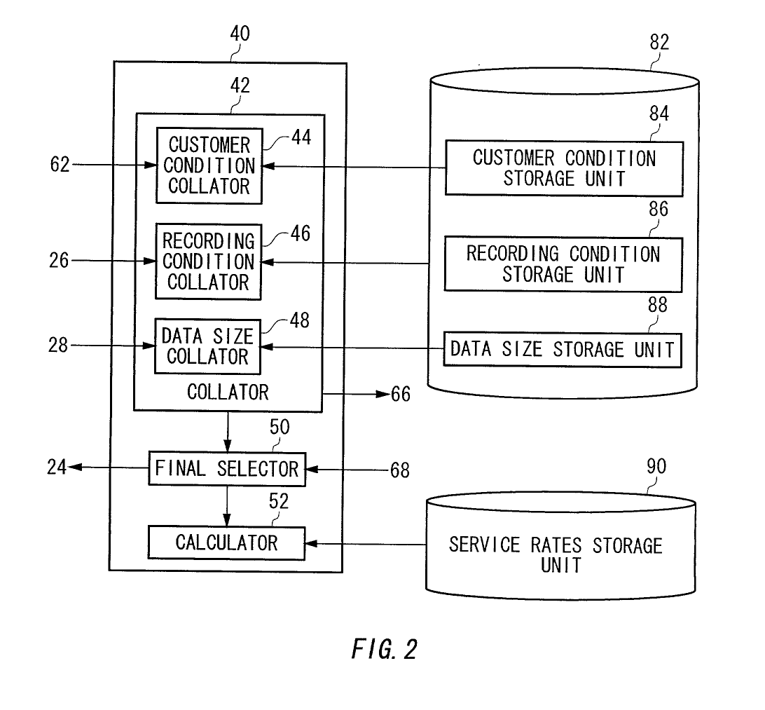

FIG. 2 is a block diagram showing the details of the digital contents selector 40 and the selection condition storage unit 82.

The selection condition storage unit 82 stores selection conditions that are selected from a plurality of digital contents stored in the digital contents storage unit 80 digital contents that are stored in the memory card 18.

The selection condition storage unit 82 includes a customer condition storage unit 84, a recording condition storage unit 86, and a data size storage unit 88. The customer condition storage unit 84 stores customer conditions for judging what kind of advertisements are to be received by customers. The recording condition storage unit 86 stores recording conditions for judging what kind of advertisements are to be received by customers according to the customers' environment for playing digital contents. The data size storage unit 88 stores data size conditions for judging which advertisements are to be selected according to the maximum recordable data size.

The digital contents selector 40 includes a collator 42, a final selector 50, and a calculator 52. The collator 42 selects several digital contents from a plurality of digital contents stored in the digital contents storage unit 80. The collator 42 includes a customer condition collator 44, a recording condition collator 46, and a data size collator 48.

The customer condition collator 44 selects digital contents by collating customer information received by the customer information input unit 62 with the customer conditions stored in the customer condition storage unit 84. The recording condition collator 46 selects digital contents by collating accessory data read by the accessory data reader 26 with the recording conditions stored in the recording condition storage unit 46. When a camera type is read as accessory data, digital contents that can be played with the camera are selected according to the playing environment. The data size collator 48 selects digital contents by collating the available memory of the memory card 18 detected by the available memory detector 28 with the data size conditions of each of the contents stored in the data size storage unit 88. The number of digital contents to be selected by the collator 42 may be single or plural.

The display 66 may display digital contents selected by the collator 42 as choices. In such a case, users may select from digital contents displayed on the display 66 digital contents for actually recording in the memory card 18 by operating the operation control 68.

The final selector 50 selects from digital contents that have been selected by the collator 42 digital contents for a final recording in the memory card 18 based on the predetermined conditions. The final selector 50 may select digital contents for recording in the memory card 18 based on the instructions made by the user using the operation control 68. The final selector 50 may also select digital contents for recording in another medium.

The service rates storage unit 90 stores information of service rates which provides discount rates for converting media in exchange for digital contents, such as advertisements, according to the type or the quantity of the advertisements. Advertisers may pay for these discounts. The calculator 52 calculates discount rates for the media conversion by referring to the service rates storage unit 90.

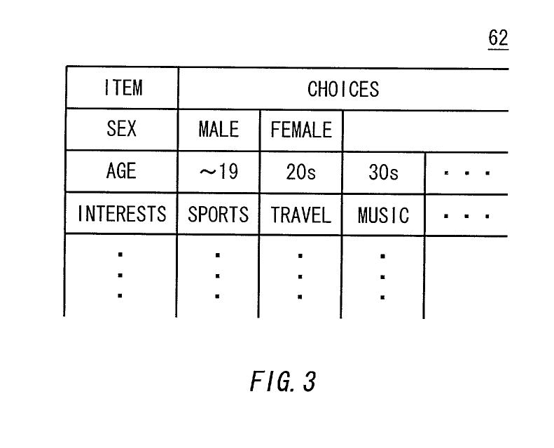

The specific examples of selection conditions stored in the selection condition storage unit 82 will be described using FIGS. 3 through 6 in the following.

FIG. 3 illustrates an exemplary customer information input by a user using the customer information input unit 62. The customer information is, for example, sex, age, interests, and the like of customers. When a customer himself or herself inputs customer information by using the customer information input unit 62, the display 66 displays items and choices for the customer to select answers about the question items. When a sales clerk of a photo shop inputs customer information, the sales clerk inputs the sex and the estimated age of the customer who handed the memory card 18 by using the customer information input unit 62 since interests of the customer are not known. In such a case, the sales clerk may ask the customer of his or her interests, or ask the customer to complete a questionnaire.

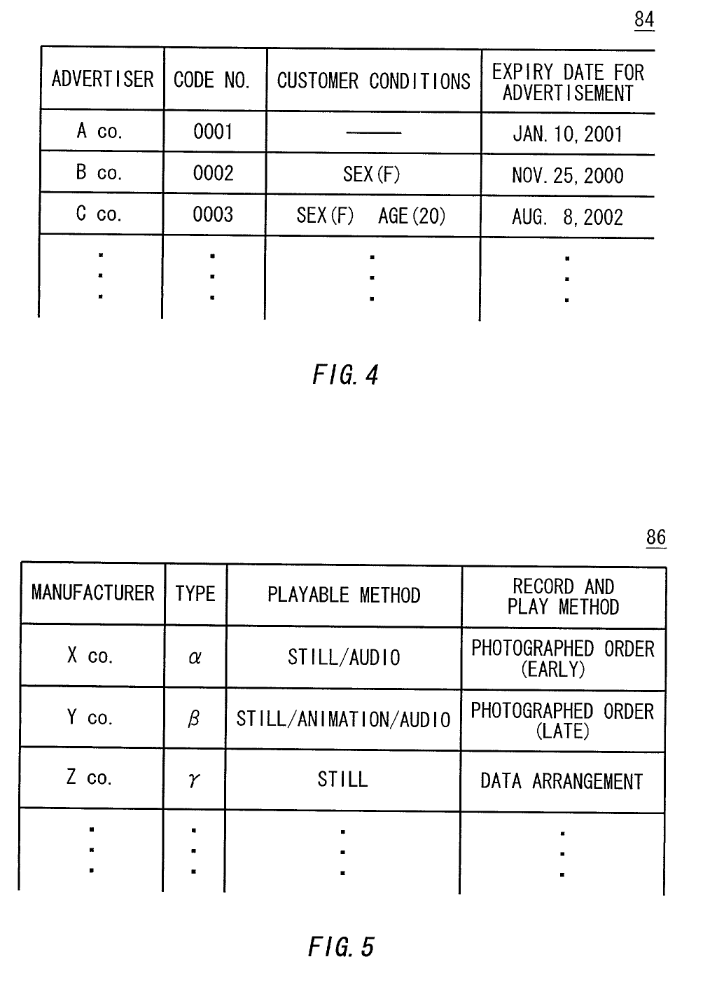

FIG. 4 is an exemplary database showing the customer conditions for each digital contents stored in the customer condition storage unit 84. The database includes an advertiser, a code number, customer conditions for the advertisement to target, and an expiry date for the advertisements, for example.

The customer condition collator 44 selects digital contents by collating customer information input by the customer information input unit 62 with customer conditions stored in the customer condition storage unit 84. For example, the advertisement with the code number 0001 provided by A Co. provides the customer conditions as “none.” Thus, this advertisement does not limit the target of customers. The advertisement with the code number 0002 provided by B Co. provides the customer conditions as “sex (F).” Thus, the target customer for this advertisement is limited to customers who input “female” in the customer information. The advertisement with the code number 0003 provided by C Co. provides the customer conditions as “sex (F), age (20).” Thus, the target customer for this advertisement is limited to customers who input “female” for sex and “20s” for age in the customer information. In this way, advertisers may narrow down the target customers since customers who are likely to have interests in their advertisements may be previously set. A plurality of customer conditions may be designated. The service rates storage unit 90 may define the discount rates for converting media according to the number of customer conditions.

FIG. 5 is an exemplary database showing the recording conditions for each camera type stored in the recording condition storage unit 86. The database includes the name of the camera manufacturer, the type, method of playing image data, and method of recording and playing, for example. The accessory data recorded in the memory card 18 with image data may contain information relating to the type of digital camera that photographed the image. The accessory data reader 26 reads from the accessory data information of the type of digital camera that photographed the image data.

The recording conditions in FIG. 5 associates camera type with methods of playing digital contents. There cording condition collator 46 selects digital contents by collating the accessory data read by the accessory data reader 26 with the recording conditions stored in the recording condition storage unit 86. For example, the digital camera with a type made by X Co. can play still image or audio data. Thus, if it is found from the accessory data read from the accessory data reader 26 that the image data recorded in the memory card 18 is the image data photographed by this digital camera, digital contents that can play still image or audio data are selected.

Also, the recording conditions associates camera type with methods of recording and playing of the digital camera. The method of recording and playing shows which data among a plurality of data a digital camera plays in advance. For example, data is played in the order of an earlier photographed date for the digital camera with α type made by X Co. Thus, a photographed date earlier than the date of the other image data is written in the digital contents as accessory data in order for the digital contents stored in the memory card 18 or another medium such as a CD-R to be played in advance. Data is played in the order of a later photographed date for the digital camera with β type made by Y Co. Thus, a photographed date later than the date of the other image data is written in the digital contents as accessory data in order for the digital contents stored in the memory card 18 or another medium such as a CD-R to be played in advance. Data to be played in advance is selected according to the data arrangement in the memory card for the digital camera with γ type made by Z Co. Therefore, digital contents are recorded in the memory card 18 or another medium such as a CD-R in order to be played in advance. Thus, digital contents may be infallibly played when playing image data. The recording conditions are not shown in the FIGS., but recording formats of digital contents may be defined.

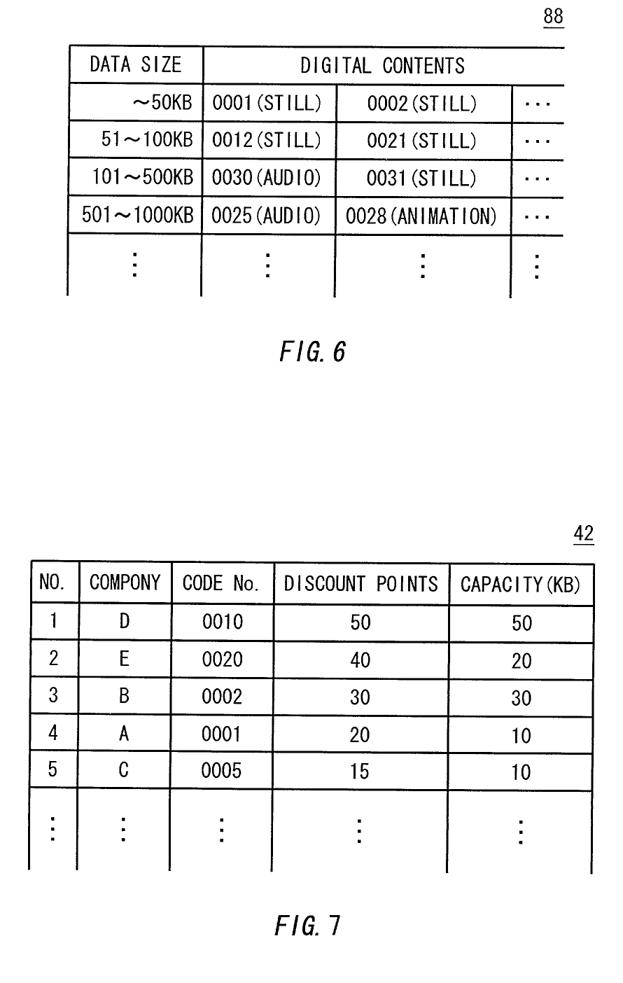

FIG. 6 is a table showing the data size of which each of the digital contents can be recorded, which the data size storage unit 88 stores. The data size collator 48 selects digital contents having smaller data size than the available memory of the memory card detected by the available memory detector 28.

The data size conditions associate data size with digital contents. For example, the digital contents with the code number 0001 are still images, and the data size is smaller than 50 KB. Thus, if the memory card 18 has available memory of more than 50 KB, these digital contents may be selected. The digital contents with the code number 0030 are audio data, and the data size is between 101 KB and 500 KB. Thus, if the memory card 18 has available memory of more than 500 KB, these digital contents may be selected. The ranges of the data sizes shown here are examples, and more detailed groupings may be arranged.

FIG. 7 is a table showing the result of the retrieved digital contents selected by the collator 42. Discount rates, or discount points, for converting media to be paid by customers are shown in the order of higher points being first, but the order of the list may be set to display in any order.

If a customer himself or herself selects digital contents, this retrieved results may be displayed on the display 66. The customer may be able to select interesting advertisements by referring to the discount rates.

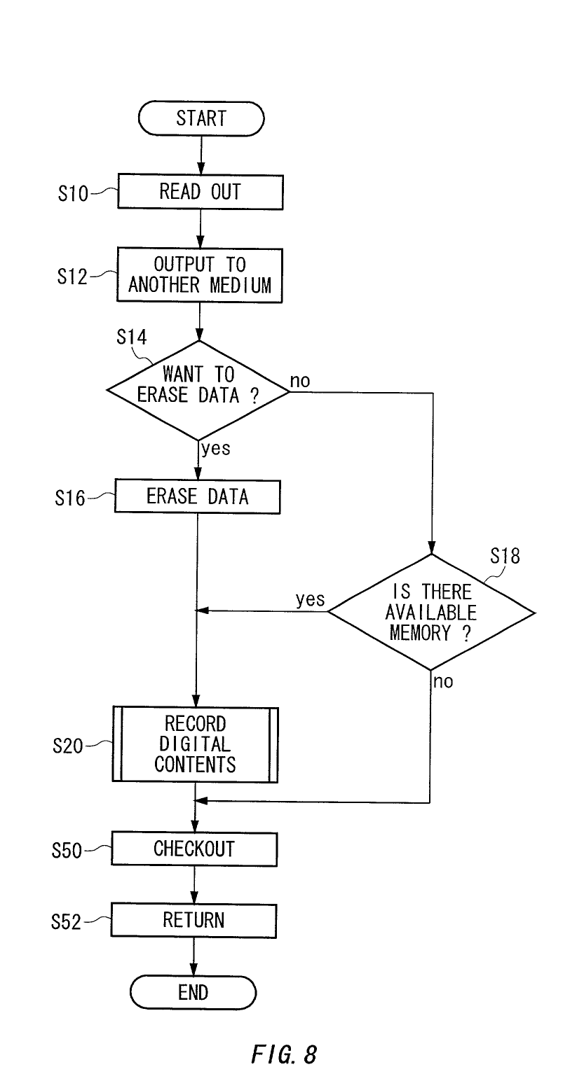

FIG. 8 is a flowchart showing the process of converting media and recording advertisements of the image data output apparatus 10.

If a user inserts the memory card 18 into a slot of the memory card drive 20, which is not shown in the FIGS. , the reader 22 reads out image data recorded in the memory card 18, at step S10. The output unit 32 converts the medium into another medium different to the memory card 18, such as a paper medium 34 or a CD-R 36, and outputs the image data, at step S12. The user inputs the after-treatment conditions, which defines whether or not to erase the image data from the memory card 18, at step S14. If the user wants to erase the image data after the media conversion is completed, the eraser 30 erases the image data from the memory card 18, at step S16. If the user does not want to erase the image data, the available memory detector 28 detects whether there is enough available memory, at step S18. The recorder 24 records advertisements selected by the digital contents selector 40 in the memory card 18, if there is enough available memory in the memory card 18, at step S20. If there is not enough available memory in the memory card 18, the process of recording advertisements is skipped. After checking out, by calculating the discount rates discounted by writing advertisements and the charge for the media conversion, at step S50, the memory card 18 is returned to the customer, at step S52. If another medium different to the memory card 18 is the CD-R 36, digital contents may be recorded in the CD-R 36. Digital contents may be stored in the CD-R 36 if the available memory of the memory card 18 is not enough.

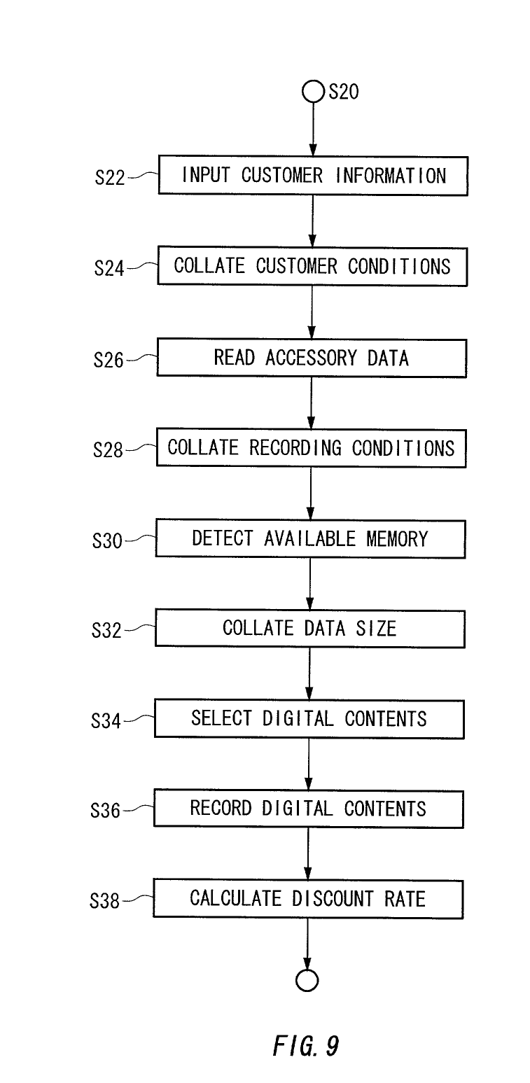

FIG. 9 is a flowchart showing the details of the process for recording advertisements at step S20 shown in FIG. 8.

A user inputs information relating to the customer using the customer information input unit 62, at step S22. The customer condition collator 44 collates the input customer information with customer conditions stored in the customer condition storage unit 84, at step S24. The accessory data reader 26 reads information such as the type of digital camera from the accessory data, at step S26. The recording condition collator 46 collates the read accessory data with the recording conditions stored in the recording conditions storage unit 86, at step S28. The available memory detector 28 detects the available memory of the memory card 18, at step S30. The data size collator 48 collates the detected available memory of the memory card 18 with the data size conditions of the advertisements stored in the data size storage unit 88, at step S32. The final selector 50 of the digital contents selector 40 selects from the advertisements narrowed down at steps S22-32 advertisements for recording in the memory card 18, at step S34.

The recorder 24 records advertisements selected by the digital contents selector 40 in the memory card 18, at step S36. The recorder 24 may record advertisements selected by the digital contents selector 40 in another medium such as a CD-R 36. The calculator 52 calculates the discount rates based on the recording of the advertisements by referring to the service rates storage unit 90, at step S38.

The second embodiment according to the present invention will be described in the following. The digital contents according to the present embodiment are pay digital data such as image data or audio data for sale.

An image data output apparatus according to the present embodiment is shown in the functional block diagram of FIGS. 1 and 2 as the image data output apparatus 10 according to the first embodiment. Thus, the structural elements having the same functions as each structural element of the image data output apparatus 10 according to the present embodiment are not described here. The service rates storage unit 90 according to the present embodiment defines sale prices of the digital contents.

The selection conditions stored in the selection condition storage unit 82 are the same as the specific examples described in FIGS. 5 and 6 in the first embodiment. The collator 42 selects some of the digital contents from the digital contents storage unit 80 according to the accessory data read by the accessory data reader 26 and the available memory of the memory card 18 detected by the available memory detector 28.

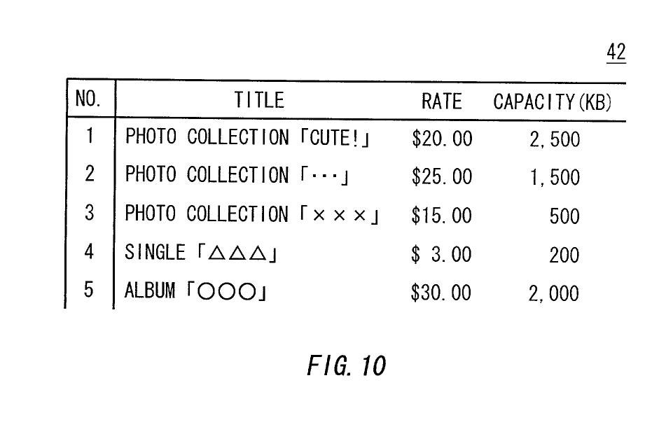

The result of the retrieved digital contents selected by the collator 42 is shown in FIG. 10. The display 66 displays this retrieved result. The customer selects digital contents that he or she wants to record in the memory card 18 by using the operation control 68 and purchases the selected digital contents.

The process for recording pay digital data in the memory card 18 is described in the following. Since the process for converting media with the image data output apparatus 10 has the same process described in FIG. 8 according to the first embodiment, the description is omitted here.

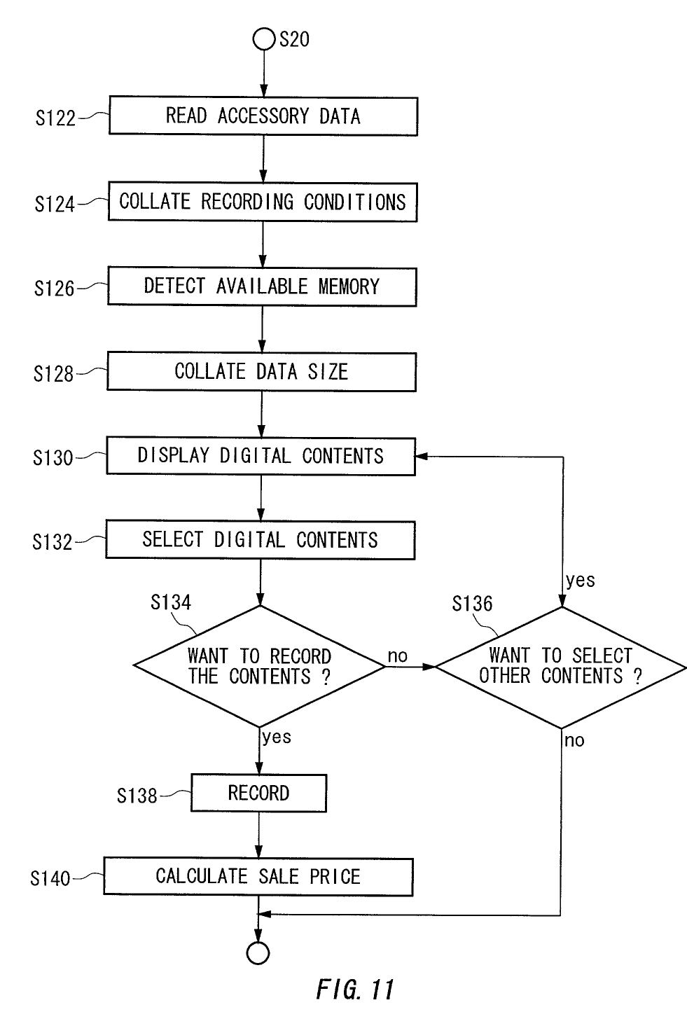

FIG. 11 is a flowchart showing the detail process for recording pay digital data at step S20 shown in FIG. 8.

The accessory data reader 26 reads information such as the type of digital camera from the accessory data, at step S122. The recording condition collator 46 collates the read accessory data with the recording conditions stored in the recording condition storage unit 86, at step S124. The available memory detector 28 detects the available memory of the memory card 18, at step S126. The data size collator 48 collates the detected available memory of the memory card 18 with the data size conditions of the pay digital data stored in the data size storage unit 88, at step S128.

The display 66 displays the pay digital data selected at steps S122-128, at step S130. The user purchases at least one of the pay digital data displayed on the display 66 and selects the pay digital data using the operation control 68, at step S132. The user decides whether or not to actually record the selected pay digital data in the memory card 18, at step S134. If the user decides to record the selected pay digital data, the recorder 24 records the pay digital data in the memory card 18, at step S138. The recorder 24 may record the pay digital data in another medium such as a CD-R 36. The calculator 52 refers to the service rates storage unit 90 and calculates the sale price for the pay digital data purchased by the customer, at step S140.

On the other hand, if the user does not decide to record the selected pay digital data, the user again inputs whether or not to select another pay digital data, at step S136. If the user selects another pay digital data, the process is returned to step S130. If the user does not select another pay digital data, the processes at steps S138 and 140 are skipped.

Now, the third embodiment according to the present invention is described in the following. According to the present embodiment, customer information is not input by the image data output apparatus but rather is input by a person using a digital camera.

The image data output apparatus according to the present embodiment is shown in functional block diagrams shown in FIGS. 1 and 2 as the image data output apparatus according to the first and second embodiments. Thus, the description of the structural elements having the same functions with each structural element of the image data output apparatus 10 according to the first and second embodiments are not described here.

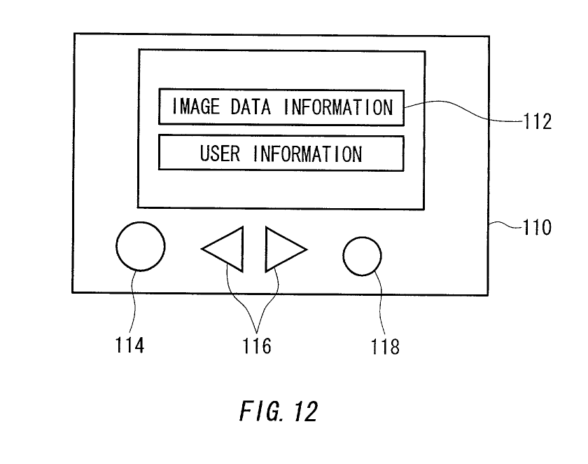

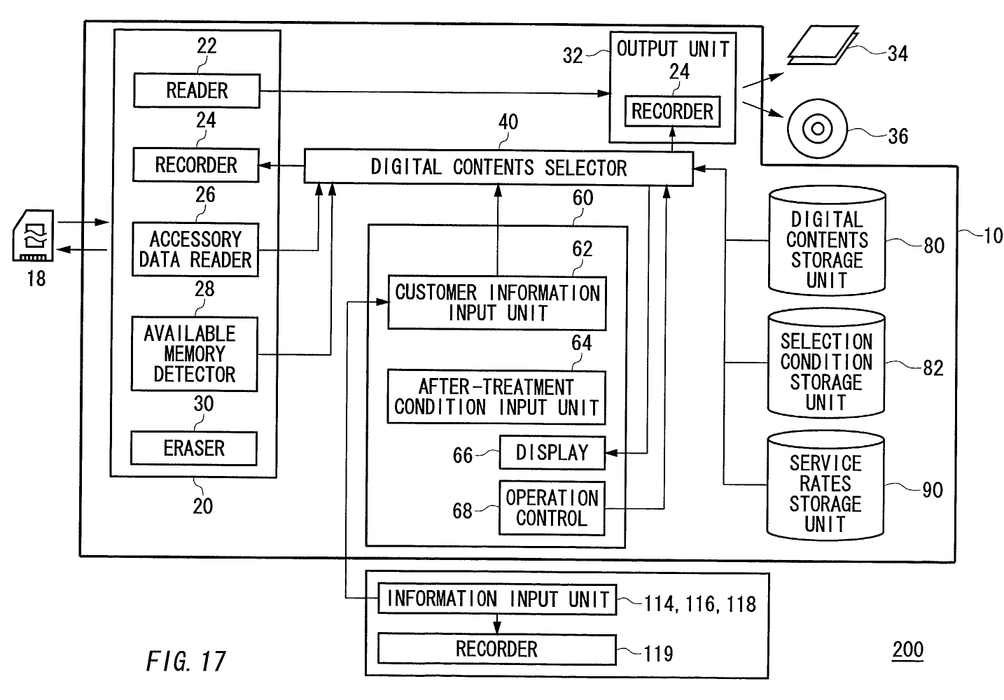

FIG. 12 illustrates an exemplary digital camera according to the present embodiment. The digital camera 110 records image data in the memory card 18. The digital camera 110 includes: data input units 114, 116, and 118; and a recorder 119, which are not shown in FIG. 12 but are shown in FIG. 17 described later. The user of the digital camera 110 operates the data input units 114, 116, and 118 and inputs information to be referred when the image data output apparatus 10 selects digital contents to be recorded in the memory card 18. The recorder records the information along with the image data in the memory card 18. This information may be recorded as accessory data in the memory card.

The information recorded in the memory card 18 includes information such as after-treatment condition and writing prohibition. The customer information is, as shown in FIG. 3 in the first embodiment, sex and age of the customer, for example. The customer information may include the name, address, and telephone number of customers. The after-treatment condition is the condition for deciding whether or not to erase at least a part of the image data from the memory card 18. The writing prohibition information is information to prohibit recording digital contents in the memory card 18.

The digital camera 110 may include a camera display 112 for displaying customer information as shown in FIG. 3 in the first embodiment.

The image data output apparatus 10 reads the accessory data from the accessory data reader 26. If customer information is included in the accessory data, the display 66 does not display the overlapping items.

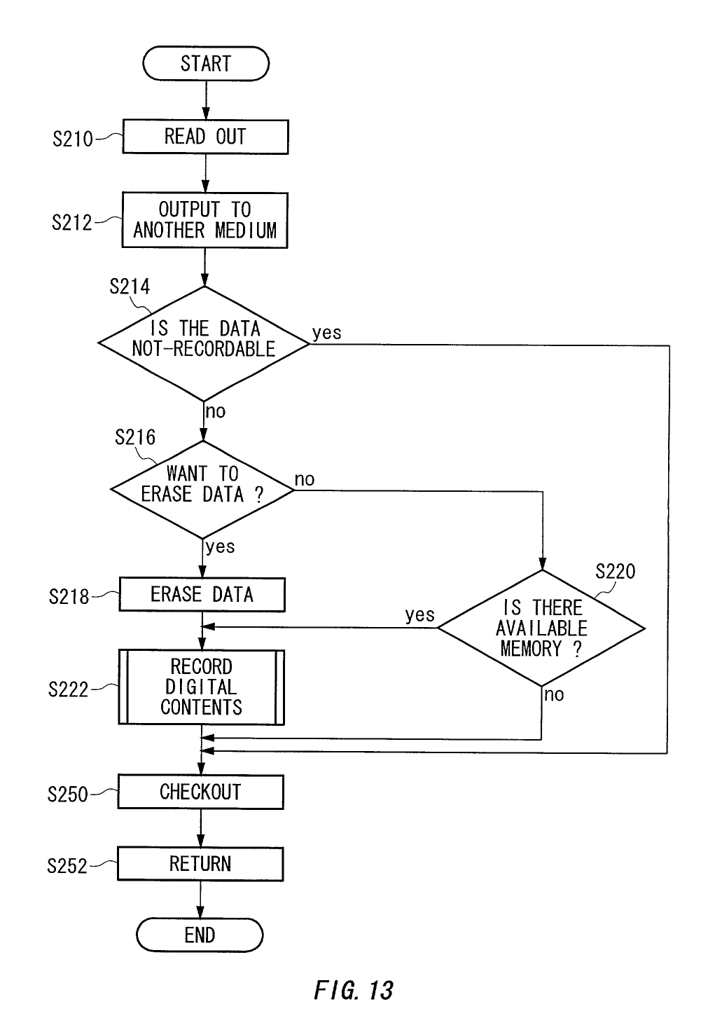

FIG. 13 is a flowchart showing the process for recording digital contents of the image data output apparatus 10 according to the present embodiment.

If a user inserts the memory card 18 into a slot of the memory card drive, which is not shown in the FIGS. , the reader 22 reads out image data recorded in the memory card 18, at step S210. The output unit 32 converts the read image data into medium other than the memory card 18, such as a paper medium 34 or a CD-R 36 and outputs the converted image data, at step S212. The accessory data reader 26 reads recording prohibition information from the memory card 18, at step S214. If the recording is not prohibited, the accessory data reader 26 reads from the memory card 18 after-treatment conditions, which determines whether or not to erase image data from the memory card 18, at step S216. If the image data is to be erased after converting to another medium, the eraser 30 erases the image data from the memory card 18, at step S218. If the image data is not to be erased, the available memory detector 28 detects whether there is enough available memory in the memory card 18, at step S220. If there is available memory in the memory card 18, the recorder 24 records digital contents selected by the digital contents selector 40 in the memory card 18, at step S222. If there is not enough available memory in the memory card 18, the process for recording digital contents at step S222 is skipped. After checking out by calculating discounts or purchased price for converting to another medium and writing digital contents, at step S250, the memory card 18 is returned to the customer, at step S252. If the recording to the memory card 18 is prohibited at step S214, the steps S216-222 are skipped and the calculation is conducted to charge for the media conversion, at step S250.

The process for recording digital contents at step S222 is the same as the process shown in FIGS. 9 and 11. According to the present embodiment, customer information is read from the accessory data recorded in the memory card 18.

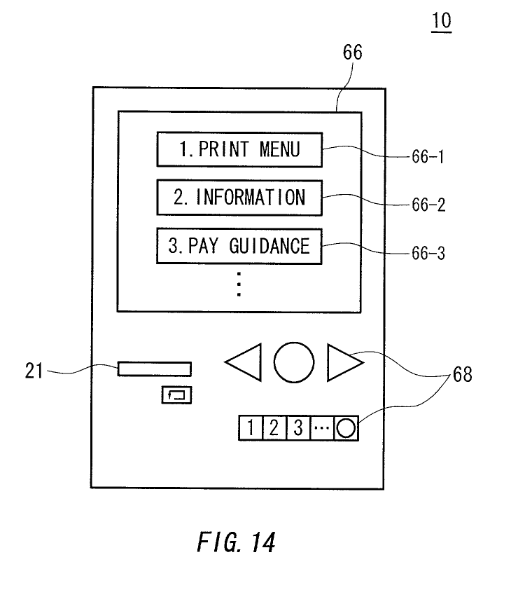

FIG. 14 is an interface for customers of the image data output apparatus 10 to operate. This image data output apparatus 10 undertakes a media conversion to print image data recorded in the memory card 18 into a paper medium 34. The number 21 is a slot for inserting the memory card 18, 66 is a display, and 68 are operation controls.

In FIG. 14, the display field “1. Print menu” is for conducting a media conversion. Users designate the number and the size of prints for an image data number with this menu. Users may input customer information such as an address and a telephone number. The display field “2. Information” is for selecting sales information and advertisements. And the display field “3. Pay guidance” is for selecting information on the latest photo collections and the latest hit music, for example. The fields may have any other titles or subjects.

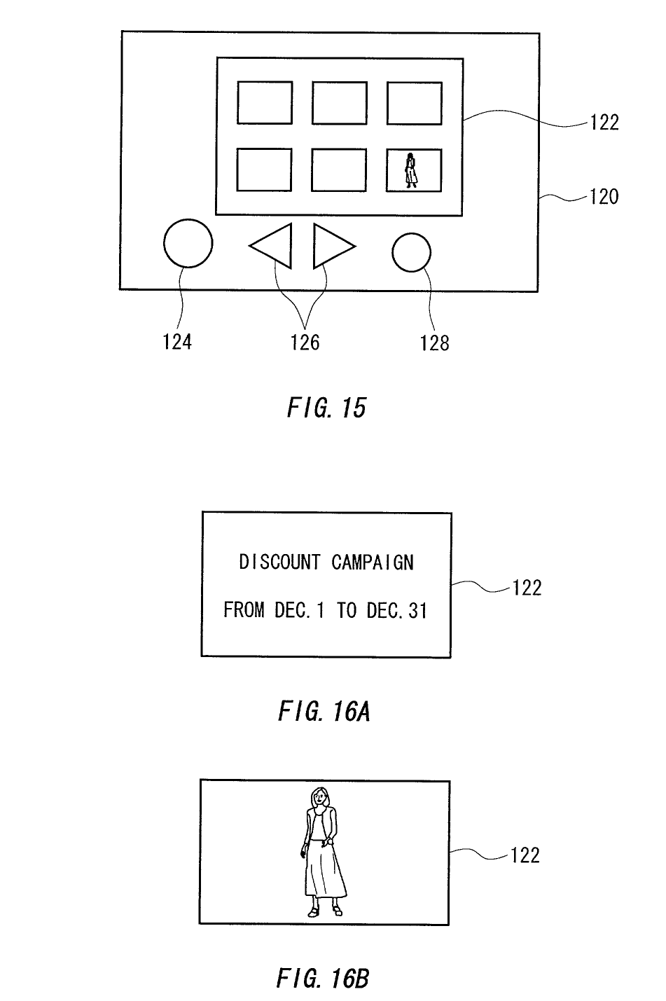

FIG. 15 illustrates an exemplary digital camera that can play digital contents recorded by using the image data output apparatus 10.

This digital camera 120 includes a camera display 122 for displaying some of the digital contents as choices, and camera operation controls 124, 126, and 128 for selecting desired digital contents from digital contents.

The image data output apparatus 10 displays digital contents as choices on the camera display 122 of the digital camera 120 as well as recording digital contents in forms that the camera operation controls 124-128 can select.

The image data output apparatus 10 may, for example, make an image data directory for storing image data photographed by a digital camera and another directory different than the image data directory in the memory card 18. The digital contents selected to be recorded in the memory card 18 may be recorded in another directory.

The camera operation control 124 of the digital camera 120 is a menu button. Users select either the image data directory or another directory by using this button. The camera operation controls 126 are selection buttons. Users select desired images and the like from the choices displayed on the camera display 122. The camera operation control 128 is a decision button. Users decide to display the selected image on the entire screen of the camera display 122 by using this button.

If the image data output apparatus 10 selects a plurality of digital contents, the camera display 122 displays a list of digital contents in thumbnails. If users select digital contents by using the select button 126, sales information and advertisements are displayed on the entire screen of the display 122 as shown in FIG. 16A.

If the digital contents are photo collections, all of the images of the photos are displayed in thumbnails, for example. Then, if the user selects one of the images, the enlarged selected image is displayed as shown in FIG. 16B.

If the digital contents are music such as hit songs, the titles of music and the pictures of album jackets are displayed in thumbnails. If the user selects a picture, the music is played.

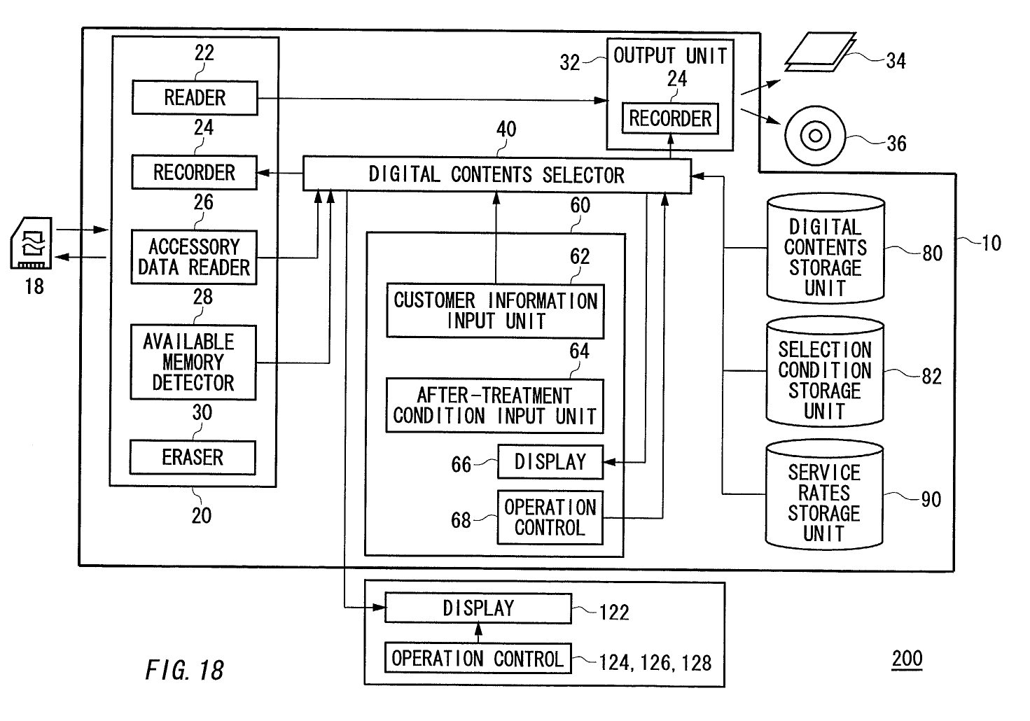

FIGS. 17 and 18 are functional block diagrams showing an image data output system 200 according to the present embodiments. The image data output system includes the image data output apparatus 10, the memory card 18, other media 34 and 36, and the image capturing apparatuses 110 and 120. The detailed description of each structural element is already explained above, so the description is omitted here.

As is obvious from the description above, digital contents such as sales information and advertisements may be received by customers in a variety of forms, according to the present invention.

Although the present invention has been described by way of exemplary embodiments, it should be understood that those skilled in the art might make many changes and substitutions without departing from the spirit and the scope of the present invention, which is defined only by the appended claims.

What is claimed is:

1. An image data output apparatus for outputting to a second medium, which is a different type of medium than a first medium, image data recorded in the first medium received from a customer, the apparatus comprising:
a reader for reading out the image data recorded in the first medium;
an output unit for outputting the image data to the second medium;
a digital contents storage unit for storing digital contents to be stored in the first medium;
a selector for selecting from a plurality of said digital contents stored in said digital contents storage unit said digital contents to be provided to the customer based on a predetermined selection condition; and
a recorder for recording said selected digital contents in the first medium.

2. The image data output apparatus as claimed in claim 1, wherein the first medium comprises a memory card in which the image data is recorded by an image capturing apparatus that records and plays the image data.

3. The image data output apparatus as claimed in claim 1, wherein said digital contents comprises advertisement information to be provided to the customer in exchange for a discount of the service rate for outputting the image data from the first medium to the second medium.

4. The image data output apparatus as claimed in claim 1, wherein said digital contents storage unit stores said digital contents to be provided in the second medium along with the image data.

5. The image data output apparatus as claimed in claim 1, wherein said recorder records said selected digital contents in the second medium.

6. The image data output apparatus as claimed in claim 1, wherein said digital contents are selected by the customer.

7. The image data output apparatus as claimed in claim 1, wherein said digital contents are selected as not being displayed when being printed.

8. The image data output apparatus as claimed in claim 1, wherein said digital contents comprise pay digital data to be received by the customer.

9. The image data output apparatus as claimed in claim 1, further comprising a customer information input unit for inputting information relating to the customer for reference, and said selector selects said digital contents by referring to said customer information.

10. The image data output apparatus as claimed in claim 1, further comprising a customer condition storage unit for storing a condition relating to the customer as said predetermined selection condition, wherein said selector selects said digital contents by collating said customer information with said customer condition.

11. The image data output apparatus as claimed in claim 1, wherein the image data includes accessory data showing the environment of which the image data is recorded in the first medium, the image data output apparatus further comprising:
an accessory data reader for reading said accessory data from the image data; and
a recording condition storage unit for storing a recording condition associating said recorded environment with a recording format of said digital contents,
wherein said selector comprises a recording condition collator for selecting said digital contents by collating said accessory data with said recording condition.

12. The image data output apparatus as claimed in claim 11, wherein said accessory data relates to the type of image capturing apparatus that photographed the image data, and said recording condition defines a recording format to be played by said image capturing apparatus.

13. The image data output apparatus as claimed in claim 1, further comprising an available memory detector for detecting available memory of the first medium, wherein said selector selects said digital contents based on said detected available memory.

14. The image data output apparatus as claimed in claim 1, further comprising a data size storage unit for storing a data size of said digital contents, wherein said selector selects said digital contents having a smaller data size than said available memory by collating said detected available memory of the first medium with said data size.

15. The image data output apparatus as claimed in claim 1, further comprising:
an after-treatment condition input unit for inputting an after-treatment condition showing whether or not to erase at least a part of the image data from the first medium after completing the reading of the image data from the first medium; and
an eraser for erasing at least a part of the image data from the first medium based on said after-treatment condition.

16. The image data output apparatus as claimed in claim 1, further comprising:
a display for displaying to the customer some of said digital contents as choices; and
an operation control for selecting desired digital contents for recording in the first medium from said digital contents displayed by said display.

17. The image data output apparatus as claimed in claim 16, wherein said operation control selects desired digital contents for providing to the second medium from said digital contents displayed by said display.

18. The image data output apparatus as claimed in claim 1, further comprising a calculator for calculating a price of said digital contents recorded in the first medium based on said predetermined selection condition.

19. The image data output apparatus as claimed in claim 18, wherein said calculator calculates the price of said digital contents recorded in the second medium based on said predetermined selection condition.

20. The image data output apparatus as claimed in claim 2, wherein the image capturing apparatus having a camera display for displaying some of said digital contents as choices and a camera operation control for selecting desired digital contents from said digital contents displays said digital contents as said choices and records said digital contents by selecting with said camera operation control.

21. An image data output system for outputting image data comprising:
a first medium for recording the image data to be received by a shop for converting a medium and for recording digital contents to be received by a customer;
a second medium for recording the image data and for recording digital contents along with the image data to be received by the customer;
a reader for reading out the image data recorded in said first medium;
an output unit for outputting the image data to said second medium;
a digital contents storage unit for storing said digital contents that the shop provides to the customer;
a selector for selecting from said digital contents storage unit said digital contents to be provided to the customer based on a predetermined selection condition;
a recorder for recording said selected digital contents in at least one of said first and second medium; and
an image capturing apparatus for outputting customer information, comprising:
an information input unit for inputting by a user's operation information for the image data output apparatus to refer to when selecting said digital contents; and
a recorder for recording said information along with the image data in at least one of said first and second medium.

22. The image data output system as claimed in claim 21, wherein said image capturing apparatus comprises:
a camera display for displaying said digital contents as choices; and
a camera operation control for selecting desired digital contents from said displayed digital contents.

23. A method for outputting image data comprising:
reading out from a first medium that stores the image data, which is recorded by an image capturing apparatus;
outputting the image data to a second medium, which is a different type of medium than said first medium;
selecting from a plurality of digital contents to be stored in at least said first medium that a shop provides to a customer; and
recording in the first medium said digital contents.

24. The method for outputting image data as claimed in claim 23, wherein said recording records said digital contents also in the second medium.

25. The method for outputting image data as claimed in claim 23, wherein said recording records said digital contents selected by said selecting based on a predetermined selection condition.

26. The method for outputting image data as claimed in claim 23, wherein said selecting comprises inputting information relating to the customer for a reference, and said selecting selects said digital contents by referring to said customer information.

27. The method for outputting image data as claimed in claim 26, wherein said digital contents is selected by the customer.

28. The method for outputting image data as claimed in claim 23, further comprising displaying displays at least one of said digital contents before displaying the image data stored in the first medium.

29. The method for outputting image data as claimed in claim 28, wherein said displaying displays at least one of said digital contents before displaying the image data stored in the second medium.

30. The method for outputting image data as claimed in claim 28, wherein said displaying is selected whether to display said digital contents when printing.

31. The method for outputting image data as claimed in claim 23, further comprising storing a condition relating to the customer as said predetermined selection condition, wherein said selecting selects said digital contents by collating said customer information with said customer condition.

32. The method for outputting image data as claimed in claim 23, wherein the image data includes accessory data showing the environment of which the image data is recorded in the first medium, the image data output apparatus further comprising:
reading said accessory data from the image data; and
storing a recording condition associating said recorded environment with a recording format of said digital contents,
wherein said selecting comprises selecting said digital contents by collating said accessory data with said recording condition.

33. The method for outputting image data as claimed in claim 23, further comprising detecting available memory of the first medium, wherein said selecting selects said digital contents based on said detected available memory.

34. The method for outputting image data as claimed in claim 23, further comprising storing a data size of said digital contents, wherein said selecting selects said digital contents having a smaller data size than said available memory by collating said available memory of the first medium with said data size.

35. The method for outputting image data as claimed in claim 23, further comprising:
inputting an after-treatment condition showing whether or not to erase at least a part of the image data from the first medium after completing the reading of the image data from the first medium; and
erasing at least a part of the image data from the first medium based on said after-treatment condition.

36. The method for outputting image data as claimed in claim 23, further comprising:
displaying to the customer some of said digital contents as choices; and
selecting desired digital contents for recording in the first medium from said digital contents displayed by said display.

37. The method for outputting image data as claimed in claim 36, wherein said selecting selects desired digital contents for recording in the second medium from said digital contents displayed by said display.

38. The method for outputting image data as claimed in claim 23, further comprising calculating a price of said digital contents recorded in the first medium based on said predetermined selection condition.

39. The method for outputting image data as claimed in claim 38, wherein said calculating calculates the price of said digital contents recorded in the second medium based on said predetermined selection condition.

40. A recording medium storing a program for outputting image data, which is executable at a computer, the program comprising:
a reading module for reading out the image data recorded in a first medium;
an outputting module for outputting the image data to a second medium;
an selecting module for selecting digital contents; and
a recording module for recording digital contents that said image capturing apparatus reproduces in one of the first and second medium.

41. The recording medium as claimed in claim 40, the program further comprising a displaying module for displaying at least one of said digital contents before displaying the image data stored in one of the first and second medium.

42. The recording medium as claimed in claim 40, the program further comprising a module for said digital contents to be selected as not being displayed when the image is printed.

43. The recording medium as claimed in claim 40, wherein said selecting module comprises inputting information relating to the customer for reference, and said selecting module selects said digital contents by referring to said customer information.

44. The recording medium as claimed in claim 40, the program further comprising a storing module for storing a condition relating to the customer as said predetermined selection condition, wherein said selecting module selects said digital contents by collating said customer information with said customer condition.

45. The recording medium as claimed in claim 40, wherein the image data includes accessory data showing the environment of which the image data is recorded in the first medium, the program further comprising:
an accessory data reading module for reading said accessory data from the image data; and
a recording condition storing module for storing a recording condition associating said recorded environment with a recording format of said digital contents,
wherein said selecting module comprises selecting said digital contents by collating said accessory data with said recording condition.

46. The recording medium as claimed in claim 40, the program further comprising an available memory detecting module for detecting available memory of the first medium, wherein said selecting module selects said digital contents based on said detected available memory.

47. The recording medium as claimed in claim 40, the program further comprising a data size storing module for storing a data size of said digital contents, wherein said selecting module selects said digital contents having a smaller data size than said detected available memory by collating said available memory of the first medium with said data size.

48. The recording medium as claimed in claim 40, the program further comprising:
an after-treatment condition inputting module for inputting an after-treatment condition showing whether or not to erase at least a part of the image data from the first medium after completing the reading of the image data from the first medium; and
an erasing module for erasing at least a part of the image data from the first medium based on said after-treatment condition.

49. The recording medium as claimed in claim 40, the program further comprising:
a displaying module for displaying to the customer some of said digital contents as choices; and
an operating module for selecting desired digital contents for recording in at least one of the first and second medium from said digital contents displayed by said display.

50. The recording medium as claimed in claim 40, the program further comprising a calculating module for calculating a price of said digital contents recorded in at least one of the first and second medium based on said predetermined selection condition.
